(19) United States
(12) Patent Application Publication
(10) Pub. No.: US 2026/0298110 A1
(43) Pub. Date: Oct. 1, 2026

(54) TURBINE SHROUD RING ASSEMBLY WITH IMPROVED LOAD PATHWAY

(71) Applicant: SAFRAN AIRCRAFT ENGINES, PARIS (FR)

(72) Inventors: Moncef M'HASNI, MOISSY-CRAMAYEL (FR); Arthur Paul Gabriel NIMHAUSER, MOISSY-CRAMAYEL (FR); Francesco SALVATORI, MOISSY-CRAMAYEL (FR); Maurice Guy JUDET, MOISSY-CRAMAYEL (FR)

(21) Appl. No.: 19/489,424

(22) PCT Filed: May 30, 2024
(86) PCT No.: PCT/FR2024/050692

§ 371 Date: Dec. 2, 2025

(30) Foreign Application Priority Data
Jun. 2, 2023 (FR) FR2305536

(51) Int. Cl. F01D 25/24; F01D 11/00

(52) U.S. Cl. CPC F01D 25/246; F01D 11/008; F05D 2240/11; F05D 2260/31; F05D 2300/6033

(57) ABSTRACT

A gas turbine ring assembly includes, about a longitudinal axis of rotation, a turbine ring including a plurality of ring segments made of ceramic matrix composite material arranged end to end circumferentially about the axis of rotation, a diffuser including a plurality of diffuser segments arranged end to end circumferentially about the axis of rotation, and a casing made of metal alloy forming a ring support structure, wherein the casing includes a central shroud which extends around the turbine ring and from which upstream and downstream annular flanges extend radially, between which a metal alloy spacer is retained including a plurality of spacer segments, each of the ring segments being supported by a diffuser segment fixed by a radial bolted connection to a spacer segment.

### TECHNICAL FIELD

The present invention relates to the field of gas turbines for aircraft (jet and propulsion engines, helicopter engines), gas turbines for electric generators and turbocharger gas turbines.

### PRIOR ART

Climate change is a major concern for many legislative and regulatory bodies around the world. Indeed, various restrictions on carbon emissions have been, are being or will be adopted by various states. In particular, an ambitious standard applies both to new types of aircraft and to those currently in circulation, requiring the implementation of technological solutions to bring them into line with current regulations. Civil aviation has now been working for several years to make its contribution to the fight against climate change.

Technological research efforts have already enabled significant improvements in the environmental performance of aircraft. The Applicant takes into account the impacting factors in all phases of design and development in order to obtain aeronautical components and products that consume less energy, are more environmentally friendly and whose integration and use in civil aviation has a moderate environmental impact, with the aim of improving the energy efficiency of these aircraft.

As a result, the Applicant is constantly working to reduce its impact on the climate by using virtuous development and manufacturing methods and processes that minimise greenhouse gas emissions as much as possible in order to reduce the environmental footprint of its activities.

This sustained research and development work is focused on new generations of aircraft turbomachines, making aircraft lighter, in particular through the materials used and lighter on-board equipment, developing the use of electrical technologies for propulsion, and, as an essential complement to technological progress, aeronautical biofuels.

The current trend in civil aeronautics is towards an increase in the temperature of gases leaving the combustion chamber, leading to a rise in the temperature of turbine components and therefore an ever-increasing need to cool these parts. However, the fresh air which enables this cooling is taken from the high-pressure compressor outlet and therefore bypasses the combustion chamber without contributing to combustion, and therefore to the efficiency of the turbomachine.

This is why the use of ceramic matrix composites (CMC) on the hottest turbine parts is currently reducing this need to cool them, because these CMC materials perform well at high temperatures (e.g. 1700° C.). They also save weight because, due to their low density (three times less than metal bases), they are lighter than the metal alloys traditionally used for these hottest parts.

However, incorporating a CMC ring into an assembly of metal parts subjected to high temperature requires designing a load pathway that does not load the CMC elements, which are more fragile than the metal elements and expand differently from the other parts, while at the same time deterministically holding them in position so as to ensure the performance of the turbomachine.

The prior art typically consists of an assembly of CMC ring segments in the shape of an inverted letter Pi. Each ring has an annular base that forms an aerodynamic duct and is held in position by two flanges that extend radially on either side of the annular base. These two flanges are held to the rest of the stator by four pins, two on the upstream side connecting the flange to a bracket, and two on the downstream side connecting the flange to the spacer. A diffuser supplying cooling air is positioned so as to cool the radially outer face of the annular flange, and is assembled with the bracket and the spacer by means of axial bolted connections (two fixings per segment) which are sensitive to vibrations and cause leakage openings reducing the performance of the turbomachine.

In order to convey the cooling air to the annular base, the bracket is pierced and the diffuser contains an air recess/duct. The drilled hole in the bracket and the recess in the diffuser must be positioned opposite each other to allow the air to pass through while minimising pressure drops, which requires the diffuser to be centred very precisely on the bracket. Further precision centring is required in order to mount the spacer with the diffuser and bracket so that all three parts can be assembled by the bolted connection. The diffuser is centred by means of a circular support, which means that the diffuser is in the load pathway from the distributor to the casing.

With this technology, the screws provide an additional mass (mass of the screws+additional mass in the spacer for tapping) and are in the load pathway with multiaxial stresses (tension+shear). Moreover, the presence of two separate parts (bracket+spacer) increases the risk of cooling air leaks between the various parts.

The positioning of the CMC ring is also complex, because the axes of the upstream and downstream pins must be parallel in order for the duct to be straight, requiring tight machining tolerances and additional checks.

### DISCLOSURE OF THE INVENTION

To this end, the present invention is the result of technological research aimed at significantly improving aircraft performance and, in this sense, contributes to reducing the environmental impact of these aircraft. The main aim of the present invention is therefore to reduce the number of parts in contact and to simplify the mounting, reduce cooling air leaks, reduce mass and cost and improve the load pathway.

These aims are achieved by a gas turbine ring assembly comprising, about a longitudinal axis of rotation, a turbine ring comprising a plurality of ring segments made of ceramic matrix composite material arranged end to end circumferentially about the axis of rotation, a diffuser comprising a plurality of diffuser segments arranged end to end circumferentially about the axis of rotation, and a casing made of metal alloy forming a ring support structure, wherein the casing comprises a central shroud which extends around the turbine ring and from which an upstream annular flange and a downstream annular flange extend radially inwards, between which a metal alloy spacer comprising a plurality of spacer segments is retained, each of the ring segments being supported by a diffuser segment fixed by a radial bolted connection to a spacer segment.

Thus, the attachment of the turbine ring to the sole diffuser, combined with the single radial fixing of the assembly to a single-piece spacer makes it possible, in addition to reducing the weight and cost, to reduce sealing leaks by simplifying the mounting of the assembly on the turbine casing.

Each spacer segment preferably comprises at least one ventilation through-hole for fluid communication with at least one corresponding ventilation hole in the diffuser segment so as to enable, through these ventilation holes, a supply of cooling air into a plenum chamber of a diffuser segment.

Advantageously, each spacer segment comprises a flat region arranged opposite a flat region of a diffuser segment so as to enable the radial bolted connection to be centred.

Each diffuser segment is preferably fixed to a ring segment by four axial fixing pins, of which two upstream fixing pins each respectively pass through a lug located at the opposite circumferential ends of an upstream tab of the ring segment and two downstream fixing pins each respectively pass through a lug located at one of the two opposite circumferential ends of a downstream tab of the ring segment.

Advantageously, the ring assembly further comprises a seal configured to provide sealing between the upstream annular flange of the casing and each spacer segment.

Each of the ventilation holes of a spacer segment is preferably divergent and comprises a dust filter mounted at the inlet of the ventilation hole on an upstream radial end wall of each spacer segment.

Advantageously, each spacer segment comprises an upstream hook and a downstream hook, each pointing upstream and mounted in an axial groove in the upstream or downstream annular flange of the casing.

Preferably, the turbine ring comprises a seal mounted in an axial groove of the spacer segment so as to provide sealing between the downstream tab of the ring segment and the downstream wall of the spacer segment.

Advantageously, the ring segments have pairs of circumferentially arranged facing grooves, and inter-segment tongues are accommodated in these grooves so as to extend between these grooves.

The invention also relates to a turbomachine comprising a turbine ring assembly as above.

### BRIEF DESCRIPTION OF THE DRAWINGS

Other features and advantages of the present invention will become apparent from the description given below, with reference to the appended drawings which illustrate an exemplary embodiment that is in no way limiting and in which:

FIG. 1 is a general view of a turbomachine,

FIG. 2 is a perspective view of a turbine ring segment and its diffuser,

FIG. 3 shows a cross-section of a turbine ring assembly in accordance with the invention,

FIG. 4 is a perspective view of a spacer segment of the turbine ring of FIG. 3, and

FIG. 5 is a top view of the diffuser of FIG. 2.

### DESCRIPTION OF THE EMBODIMENTS

In the remainder of the description, the terms “upstream” and “downstream” will be used in reference to the axial direction of flow of the gas stream in the turbine and the terms “inner” or “inside” and “outer” or “outside” will be used in the perpendicular direction depending on whether or not the object concerned is in contact with this gas stream.

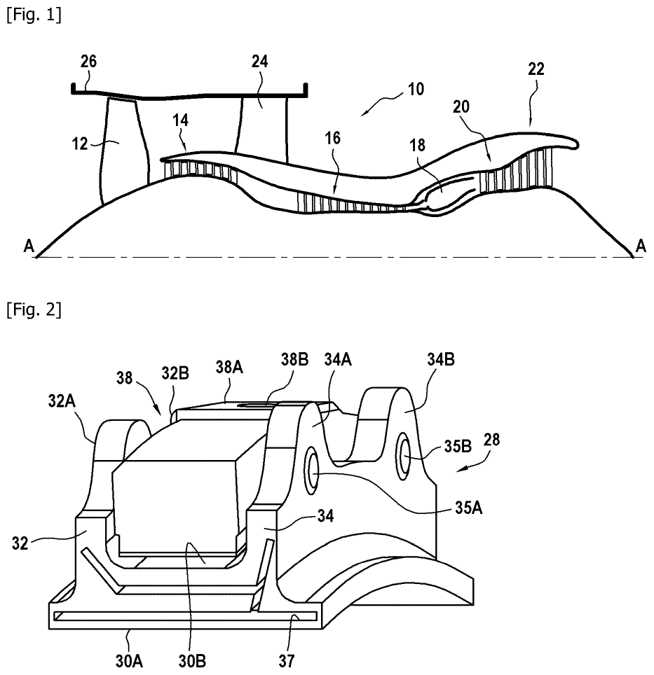

FIG. 1 illustrates, in longitudinal section and by way of example, a dual body aircraft turbofan turbomachine 10 comprising, from upstream to downstream: a fan 12, a first low-pressure compressor 14 and a second high-pressure compressor 16, a combustion chamber 18 and a gas turbine 20, these components, with the exception of the fan, being mounted in a casing 22 forming an internal passage duct for the primary hot flow stream of the turbomachine. Guide vanes 24 mounted between the casing 22 and a nacelle 26 channel the turbomachine secondary flow. The metal casing 22 forms the support structure for ceramic matrix composite (CMC) turbine ring angular segments arranged circumferentially over 360°, so as to form a segmented turbine ring (discontinuous cylindrical shape with inter-segment clearances) surrounding the rotating blade assemblies of the turbomachine.

As illustrated in FIG. 2, each turbine ring angular segment 28 has a cross-section substantially in the shape of the inverted Greek letter π (pi) with an annular base whose radially inner face 30A that is coated with a layer of abradable material delimits the aerodynamic hot air stream in the gas turbine and a radially outer face 30B from which an upstream tab 32 and a downstream tab 34 extend radially outwards. These two tabs, which extend in the circumferential direction over the entire width of the angular ring segment 28, are axially spaced apart and, for example, each have two lugs 32A, 32B; 34A, 34B, each of which is pierced by an axial orifice intended to receive an axial fixing pin (only the downstream axial fixing pins 35A and 35B are illustrated). As illustrated, there are advantageously four upstream and downstream pins (two per tab) per ring segment. The drilled holes for the pins are advantageously produced in a single pass, so as to make it easier to ensure that the upstream and downstream pins are coaxial.

In a known manner, the sealing between angular ring segments is ensured by inter-segment tongues (not shown) housed in grooves 37 of the angular ring segments, which have pairs of circumferentially arranged facing grooves.

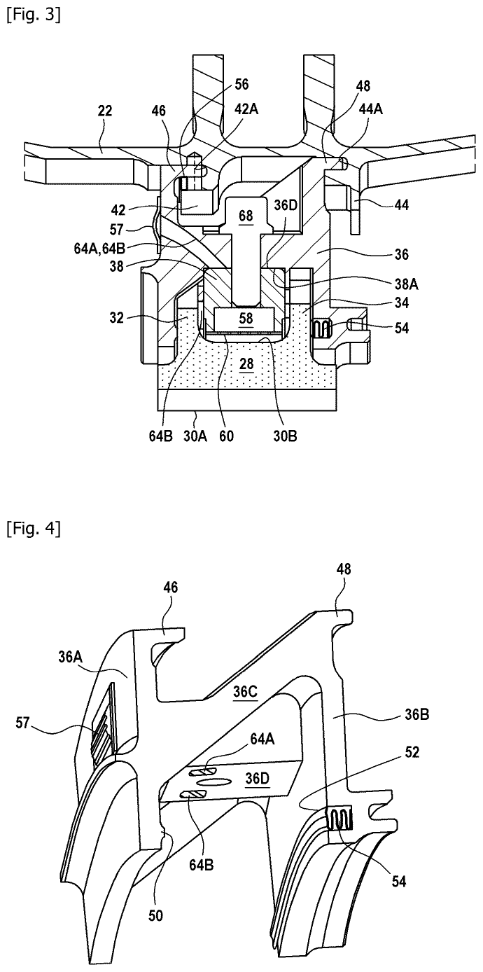

As illustrated in FIG. 3, the angular ring segments 28 are supported by the casing 22 through successive spacer segments 36 and diffuser segments (segmented diffusers 38). Spacer segments and diffuser segments are assembled end-to-end circumferentially. More specifically, the casing 22 comprises a central shroud which extends around the turbine ring and from which an upstream annular flange 42 extends radially inwards, provided with an upstream annular groove 42A which extends axially and opens towards the upstream, and a downstream annular flange 44 provided with a downstream annular groove 44A which extends axially and also opens towards the upstream. These upstream and downstream annular grooves are designed to receive upstream hooks 46 and downstream hooks 48 pointing upstream in the form of a ring segment of the spacer segment 36.

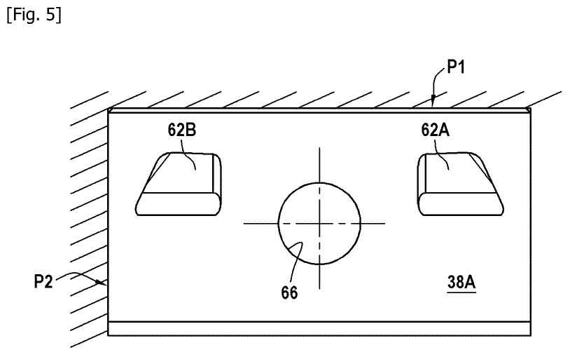

The spacer segment, which is advantageously made of a metal alloy and is illustrated in perspective in FIG. 4, is in the form of a one-piece part of substantially H shape with an oblique bar (or inverted N), with an upstream radial wall 36A (forming the first arm of the H), the outer end of which projects downstream to form the upstream hook 46, a downstream radial wall 36B (forming the second arm of the H), the outer end of which projects downstream to form the downstream hook 48, and a central wall 36C (forming the oblique bar of the H) connecting the upstream and downstream radial walls. The inner end of the upstream radial wall 36A comprises a support 50 extending axially downstream to support the upstream tab 32 of the ring segment 28, and the inner end of the downstream radial wall 36B comprises an axial groove 52 extending axially and opening upstream and intended to receive a flexible support 54, typically machined from a metal alloy having an S or W shape, to support the downstream tab 34 of the ring segment 28 and thus make it possible to compensate for the different axial expansions of the turbine ring and the metal parts. The upstream and downstream sealing of the ring is controlled by a seal (typically an Omega seal 56) (see FIG. 3) mounted between the upstream annular flange 42 and the upstream radial wall 36A of the spacer segment.

A dust filter 57 is mounted on the upstream wall 36A of the spacer segment, at the entrance to at least one ventilation hole 64A, 64B, which advantageously diverges and ensures the circulation of cooling air through the spacer segment 36.

Returning to FIG. 3, the segmented diffuser 38 comprises a plurality of blind cavities in its two side walls, intended to receive the axial fixing pins, which are advantageously coaxial, although this is not a requirement, as the holes need not be coaxial for integration purposes. The segmented diffuser 38 also typically comprises an internal plenum chamber 58 closed by a radially inner diffuser plate 60 pierced by a plurality of air ejection orifices. On an opposite, radially outer wall, a flat region 38A is machined, intended to cooperate with a corresponding flat region 36D of the spacer segment 36, the spacer segment and the segmented diffuser being pierced by coaxial orifices 66 to receiving a radial bolted connection 68, typically one assembly screw per spacer segment. Thus, with the invention, the conventional axial bolted connection with two screws is replaced by a radial bolted connection with a single screw that connects the diffuser ring assembly to the spacer. This improves the ability of the spacer to absorb the loads from the high-pressure distributor (HPD) and transmit them to the casing without loading the turbine ring, as the bolted connection only works in tension and is outside the flow of loads from the distributor, which now passes through the oblique bar of the H. As a result, the fixing is less subject to vibrations. This configuration also makes it possible to reduce the number of parts, thus limiting costs and leaks, as well as saving weight.

Moreover, with the invention, the drilling of holes of the pin housings on the spacer carried out in the prior art is eliminated and by holding the pins and the ring by the diffuser, better control of the aerodynamic stream is ensured because the drilled holes for the pins are produced by machining in a single pass, and therefore it is easier to ensure that they are coaxial.

FIG. 5, together with preceding FIGS. 3 and 4, illustrate the passage of cooling air through the segmented diffuser. This fluid introduced via the dust filter 57 mounted on the upstream wall 36A of the spacer segment and passing through the ventilation holes 64A, 64B drilled in this spacer segment 36 is then routed through at least one corresponding advantageously divergent ventilation hole (for example 62A, 62B) of the segmented diffuser 38, in order to reach the plenum chamber 58 before impacting the inner face 30A of the annular base through the diffuser plate 60.

It should be noted that the invention allows for simplified mounting because only one centring is now required, which is that of the diffuser with the spacer, achieved by means of only two flat supports P1, P2. Thus the mounting is carried out as follows:
(1): positioning the ring 28 on the diffuser 38,
(2): fixing the resulting assembly using axial pins 35A, 35B,
(3): positioning the assembly thus fixed onto the spacer 36 and fixing by the radial assembly screw 68, and
(4): hooking the assembly onto the annular flanges of the casing 42, 44.

The invention improves the incorporation of a CMC ring in a modern engine. Mass is saved by eliminating the need for fixing screws between parts, thickness is reduced by using more direct load paths, and strength is improved by eliminating the need for bolted connections under multiaxial loads. This simplifies machining and mounting and eliminates the leaks that exist between the parts in the prior art.

1. A gas turbine ring assembly comprising, about a longitudinal axis of rotation, a turbine ring comprising a plurality of ring segments made of ceramic matrix composite material arranged end to end circumferentially about the axis of rotation, a diffuser comprising a plurality of diffuser segments arranged end to end circumferentially about the axis of rotation, and a casing made of metal alloy forming a ring support structure, wherein the casing comprises a central shroud which extends around the turbine ring and from which extend, radially inwards, an upstream annular flange and a downstream annular flange between which a metal alloy spacer comprising a plurality of spacer segments is retained, wherein each of the ring segments is supported by a diffuser segment fixed by a radial bolted connection to a spacer segment, wherein each diffuser segment is fixed to a ring segment by four axial fixing pins, including two upstream fixing pins each respectively passing through a lug located at one of the two opposite circumferential ends of an upstream tab of the ring segment and two downstream fixing pins each respectively passing through a lug located at one of the two opposite circumferential ends of a downstream tab of the ring segment.

2. The turbine ring assembly according to claim 1, wherein each spacer segment comprises at least one ventilation through-hole for fluid communication with at least one corresponding ventilation hole in the diffuser segment so as to allow, through these ventilation holes, a supply of cooling air into a plenum chamber of a diffuser segment.

3. The turbine ring assembly according to claim 1, wherein each spacer segment comprises a flat region arranged opposite a flat region of a diffuser segment so as to enable centring of the radial bolted connection.

4. The turbine ring assembly according to claim 1, comprising a seal configured to provide sealing between the upstream annular flange of the casing and each spacer segment.

5. The turbine ring assembly according to claim 1, wherein each of the ventilation holes of a spacer segment is divergent and comprises a dust filter mounted at the inlet of the ventilation hole on an upstream radial end wall of each spacer segment.

6. The turbine ring assembly according to claim 1, wherein each spacer segment comprises an upstream hook pointing upstream and mounted in an axial groove of the upstream annular flange of the casing, and a downstream hook pointing upstream and mounted in an axial groove of the downstream annular flange of the casing.

7. The turbine ring assembly according to claim 6, comprising a seal mounted in an axial groove of the spacer segment so as to provide sealing between the downstream tab of the ring segment and the downstream wall of the spacer segment.

8. The turbine ring assembly according to claim 1, wherein the ring segments have pairs of circumferentially arranged facing grooves, inter-segment tongues being accommodated in these grooves so as to extend between these grooves.

9. An aeronautical turbomachine comprising a turbine ring assembly according to claim 1.

10. The turbine ring assembly according to claim 1, wherein each diffuser segment comprises, on its side walls, a plurality of blind cavities intended to receive the axial fixing pins.
